(19) United States
(12) Patent Application Publication
(10) Pub. No.: US 2026/0171884 A1
(43) Pub. Date: Jun. 18, 2026

(54) SEMICONDUCTOR DEVICE

(71) Applicant: FUJI ELECTRIC CO., LTD., Kawasaki-shi (JP)

(72) Inventor: Taizo ASANO, Matsumoto-city (JP)

(73) Assignee: FUJI ELECTRIC CO., LTD., Kawasaki-shi (JP)

(21) Appl. No.: 19/373,582

(22) Filed: Oct. 29, 2025

(30) Foreign Application Priority Data
Dec. 16, 2024 (JP) 2024-220153

(51) Int. Cl. H02M 1/00; H02M 3/158

(52) U.S. Cl. CPC H02M 1/0003; H02M 3/158

(57) ABSTRACT

A semiconductor device, including: an output unit that is connected to a load and includes a high-side switching element and a low-side switching element for driving the load; a high-side circuit, including a high-side operation detection circuit, which detects an operation state of the high-side switching element and generates first operation information, and a transmission circuit, which transmits the first operation information; and a low-side circuit, including a low-side operation detection circuit, which detects an operation state of the low-side switching element and generates second operation information, and an operation information notification circuit, which receives the first operation information transmitted from the high-side circuit by the transmission circuit and the second operation information, and notifies a periphery of data that includes at least one of the first operation information or the second operation information.

### CROSS-REFERENCE TO RELATED APPLICATION

This application is based upon and claims the benefit of priority of the prior Japanese Patent Application No. 2024-220153, filed on December 16, 2024, the entire contents of which are incorporated herein by reference.

### BACKGROUND OF THE INVENTION

### 1. Field of the Invention

The embodiment discussed herein relates to a semiconductor device.

### 2. Background of the Related Art

A semiconductor device in which switching elements, which are power semiconductors, are incorporated on a high side and a low side has a configuration that outputs operation information, such as a temperature state during operation of the switching elements, to the outside.

As one example of a related technology, a technology has been proposed in which an abnormality detection signal held in an upper arm circuit is transmitted to a circuit unit based on an earth potential during an ON period of a main switching element on a lower arm (see Japanese Laid-open Patent Publication No. 2004-304929). In addition, a technology has been proposed in which information is transmitted using a current flowing through a diode by switching a signal switching element of a signal transmission circuit (see Japanese Laid-open Patent Publication No. 2019-004535). In another proposed technique, information needed by a protection operation for a semiconductor element that constructs a power conversion apparatus is detected, an alarm signal with a pulse width corresponding to a protection factor is generated, and the alarm signal is output to the periphery (see Japanese Laid-open Patent Publication No. 2014-093903).

### SUMMARY OF THE INVENTION

According to an aspect of the present disclosure, there is provided a semiconductor device, including: an output unit that is connected to a load and includes a high-side switching element and a low-side switching element for driving the load; a high-side circuit, including: a high-side operation detection circuit, which detects an operation state of the high-side switching element and generates first operation information, and a transmission circuit, which transmits the first operation information; and a low-side circuit, including: a low-side operation detection circuit, which detects an operation state of the low-side switching element and generates second operation information, and an operation information notification circuit, which receives the first operation information transmitted by the transmission circuit of the high-side circuit and the second operation information, and notifies a periphery of the semiconductor device of data that includes at least one of the first operation information or the second operation information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a diagram useful in explaining one example of a semiconductor device;

FIG. 2 depicts the configuration of a semiconductor device according to a comparative example;

FIG. 3 depicts an example configuration of a semiconductor device;

FIG. 4 depicts an example configuration of a high-side circuit;

FIG. 5 depicts example internal configurations of a high-side circuit and a low-side circuit;

FIG. 6 is a diagram depicting an example of bit allocation in notification data;

FIGS. 7A and 7B depict example waveforms of a clock signal indicating a start of communication and an end of communication of an operation detection pulse, where FIG. 7A illustrates a case where a plurality of pieces of operation information are transmitted during a period from the start of communication to the end of communication and FIG. 7B illustrates a case where a single piece of operation information is transmitted during a period from the start of communication to the end of communication;

FIG. 8 depicts the configuration of a modification of an HVIC;

FIG. 9 is an example timing chart of operation waveform pulse transmission;

FIG. 10 depicts the configuration of a modification to an HVIC that includes a gate drive function; and

FIG. 11 is an example timing chart of a data transmission function.

### DETAILED DESCRIPTION OF THE INVENTION

An embodiment will be described below with reference to the accompanying drawings. Note that, in this specification and the accompanying drawings, structural elements that have substantially the same structure have been assigned the same reference numerals, and duplicated description of such elements may be omitted.

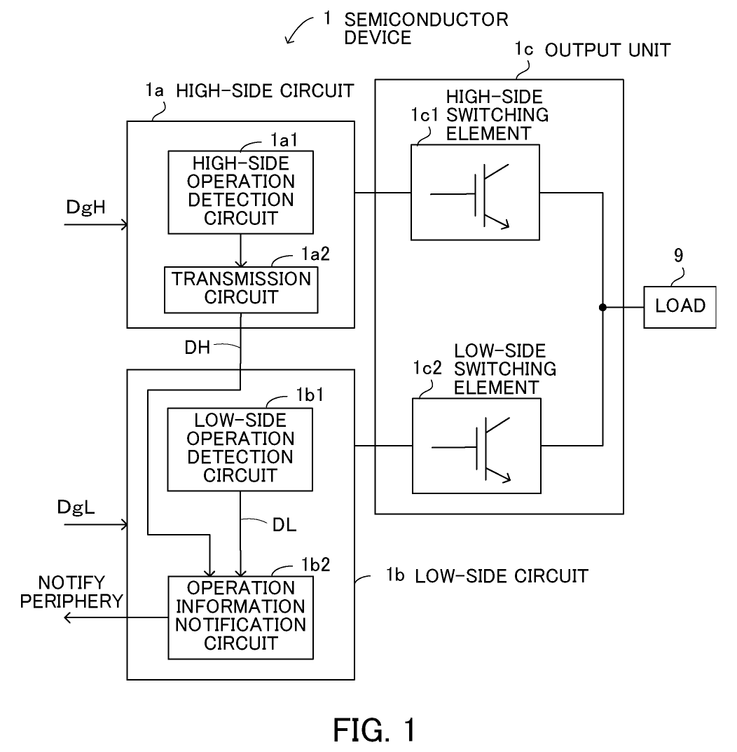

FIG. 1 is a diagram useful in explaining one example of a semiconductor device. A semiconductor device 1 includes a high-side circuit 1a, a low-side circuit 1b, and an output unit 1c. The high-side circuit 1a includes a high-side operation detection circuit 1a1 and a transmission circuit 1a2. The low-side circuit 1b includes a low-side operation detection circuit 1b1 and an operation information notification circuit 1b2. The output unit 1c includes a high-side switching element 1c1 and a low-side switching element 1c2.

The high-side circuit 1a drives switching of the high-side switching element 1c1 based on a high-side driving control signal DgH transmitted from the periphery. The low-side circuit 1b drives switching of the low-side switching element 1c2 based on a low-side driving control signal DgL transmitted from the periphery. The high-side switching element 1c1 and the low-side switching element 1c2 are connected to a load 9, and drive the load 9 through switching operations.

The high-side operation detection circuit 1a1 detects an operation state of the high-side switching element 1c1 and generates first operation information DH. The transmission circuit 1a2 transmits the first operation information DH to the low-side circuit 1b.

The low-side operation detection circuit 1b1 detects an operation state of the low-side switching element 1c2 and generates second operation information DL. The operation information notification circuit 1b2 receives the first operation information DH transmitted from the high-side circuit 1a and the second operation information DL on the low-side circuit 1b side, and notifies the periphery of at least one of the first operation information DH and the second operation information DL.

As described above, in the semiconductor device 1, the first operation information relating to the operation state of the high-side switching element 1c1 detected by the high-side circuit 1a is transmitted to the low-side circuit 1b. The low-side circuit 1b notifies the periphery of at least one of the transmitted first operation information and the second operation information relating to the operation state of the low-side switching element 1c2 detected by the low-side circuit 1b.

With this configuration, it is possible to provide the periphery with collective notification of the first operation information on the high side and the second operation information on the low side. This means for example that it is possible to reduce the number of output pins for the operation information and to miniaturize the device by reducing the scale of the device.

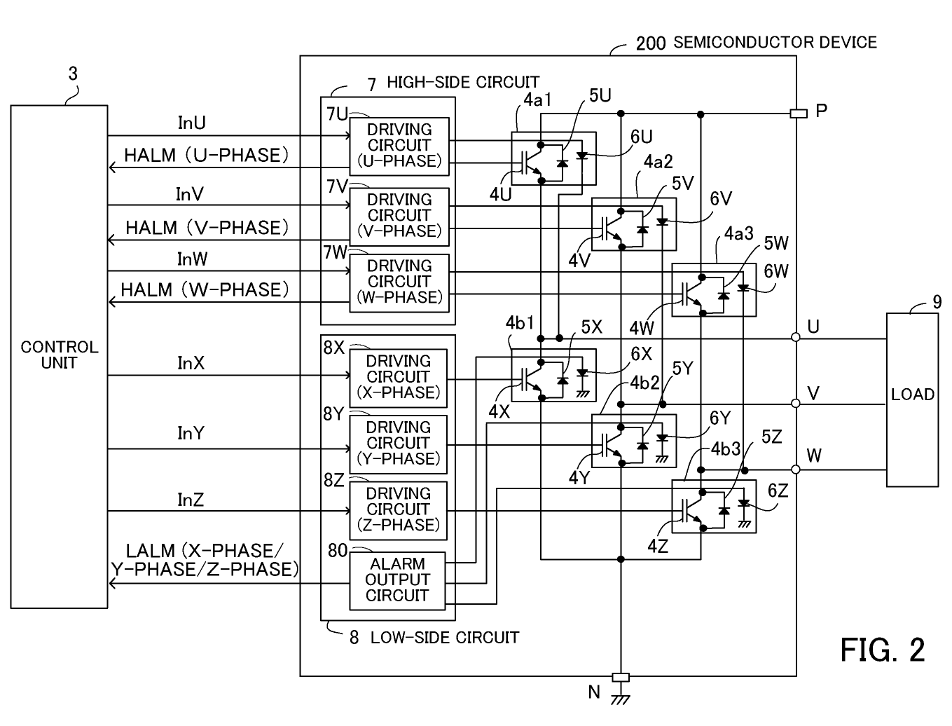

Next, a semiconductor device according to a comparative example will be described with reference to FIG. 2. FIG. 2 depicts the configuration of a semiconductor device according to a comparative example. A semiconductor device 200 according to this comparative example includes a high-side circuit 7, high-side switching circuits 4a1, 4a2, and 4a3, a low-side circuit 8, and low-side switching circuits 4b1, 4b2, and 4b3.

The high-side circuit 7 includes driving circuits 7U, 7V, and 7W, and the low-side circuit 8 includes driving circuits 8X, 8Y, and 8Z and an alarm output circuit 80. The U-phase high-side switching circuit 4a1 includes a switching element 4U, a freewheeling diode (FWD) 5U, and a temperature detection diode 6U. The V-phase high-side switching circuit 4a2 includes a switching element 4V, an FWD 5V, and a temperature detection diode 6V. The W-phase high-side switching circuit 4a3 includes a switching element 4W, an FWD 5W, and a temperature detection diode 6W.

The X-phase low-side switching circuit 4b1 includes a switching element 4X, an FWD 5X, and a temperature detection diode 6X. The Y-phase low-side switching circuit 4b2 includes a switching element 4Y, an FWD 5Y, and a temperature detection diode 6Y. The Z-phase low-side switching circuit 4b3 includes a switching element 4Z, an FWD 5Z, and a temperature detection diode 6Z.

The high-side switching elements 4U, 4V, and 4W are provided between a positive terminal P and output terminals U, V, and W of the respective phases, and the low-side switching elements 4X, 4Y, and 4Z are provided between the output terminals U, V, and W of the respective phases and a negative terminal N. A load 9 is connected to the output terminals U, V, and W.

The FWDs 5U, 5V, and 5W are connected in antiparallel to the switching elements 4U, 4V, and 4W, respectively, and commutate a load current. Similarly, the FWDs 5X, 5Y, and 5Z are connected in antiparallel to the switching elements 4X, 4Y, and 4Z, respectively, and commutate the load current.

The anode of the temperature detection diode 6U that detects the temperature of the switching element 4U is connected to the U-phase driving circuit 7U, and the cathode of the temperature detection diode 6U is connected to an output terminal U. The anode of a temperature detection diode 6V that detects the temperature of the switching element 4V is connected to the V-phase driving circuit 7V, and the cathode of the temperature detection diode 6V is connected to an output terminal V. The anode of the temperature detection diode 6W that detects the temperature of the switching element 4W is connected to the W-phase driving circuit 7W, and the cathode of the temperature detection diode 6W is connected to an output terminal W.

On the other hand, the anode of the temperature detection diode 6X that detects the temperature of the switching element 4X is connected to the alarm output circuit 80, and the cathode of the temperature detection diode 6X is connected to GND. The anode of the temperature detection diode 6Y that detects the temperature of the switching element 4Y is connected to the alarm output circuit 80, and the cathode of the temperature detection diode 6Y is connected to GND. The anode of the temperature detection diode 6Z that detects the temperature of the switching element 4Z is connected to the alarm output circuit 80, and the cathode of the temperature detection diode 6Z is connected to GND.

The driving circuit 7U performs driving control of the switching element 4U based on a driving control signal InU transmitted from the control unit 3. The driving circuit 7U also generates an alarm signal HALM (U-phase) relating to the temperature state of the switching element 4U based on the temperature signal from the temperature detection diode 6U, and transmits the alarm signal HALM (U-phase) to the control unit 3.

The driving circuit 7V performs driving control of the switching element 4V based on a driving control signal InV transmitted from the control unit 3. The driving circuit 7V also generates an alarm signal HALM (V-phase) relating to the temperature state of the switching element 4V based on the temperature signal from the temperature detection diode 6V, and transmits the alarm signal HALM (V-phase) to the control unit 3.

The driving circuit 7W performs driving control of the switching element 4W based on a driving control signal InW transmitted from the control unit 3. The driving circuit 7W also generates an alarm signal HALM (W-phase) relating to the temperature state of the switching element 4W based on the temperature signal from the temperature detection diode 6W, and transmits the alarm signal HALM (W-phase) to the control unit 3.

On the other hand, the driving circuit 8X performs driving control of the switching element 4X based on a driving control signal InX transmitted from the control unit 3, and the driving circuit 8Y performs driving control of the switching element 4Y based on a driving control signal InY transmitted from the control unit 3. The driving circuit 8Z performs driving control of the switching element 4Z based on a driving control signal InZ transmitted from the control unit 3.

The alarm output circuit 80 generates an alarm signal LALM (X-phase) relating to the temperature state of the switching element 4X based on the temperature signal from the temperature detection diode 6X, and transmits the alarm signal LALM (X-phase) to the control unit 3. The alarm output circuit 80 also generates an alarm signal LALM (Y-phase) relating to the temperature state of the switching element 4Y based on the temperature signal from the temperature detection diode 6Y, and transmits the alarm signal LALM (Y-phase) to the control unit 3. The alarm output circuit 80 also generates an alarm signal LALM (Z-phase) relating to the temperature state of the switching element 4Z based on the temperature signal from the temperature detection diode 6Z, and transmits the alarm signal LALM (Z-phase) to the control unit 3.

As described above, in the configuration of the semiconductor device 200 according to the comparative example, the number of output lines for a high-side alarm signal is three, and the number of output lines of a low-side alarm signal is one. This means that the number of pins for outputting alarm signals is increased, resulting in the problem of an increase in the scale of the apparatus. The present embodiment was conceived in view of this problem, and aims to miniaturize the apparatus through a reduction in scale achieved by aggregating operation information on the switching elements (which corresponds to alarm signals) when notifying the periphery.

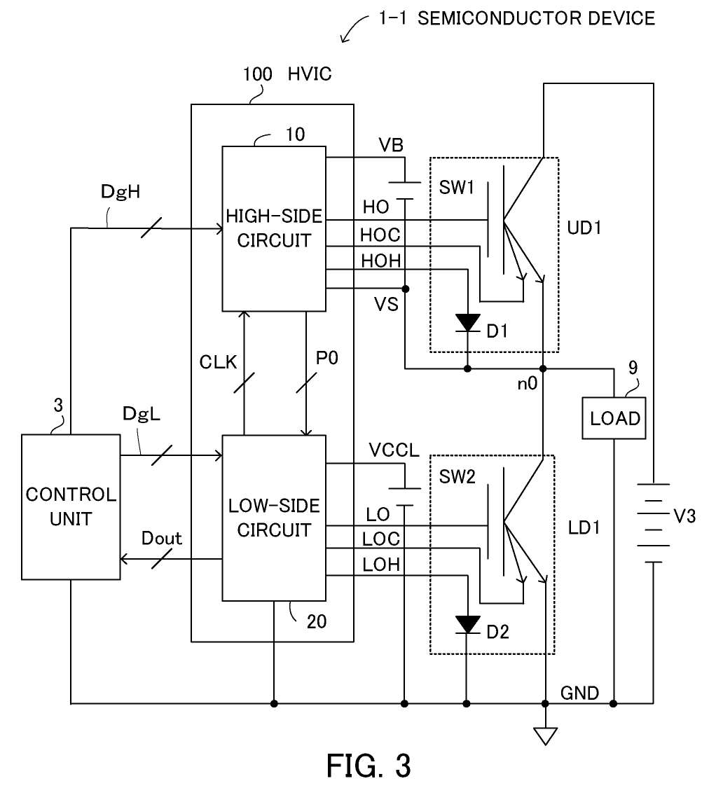

Next, the semiconductor device according to the present embodiment will be described in detail. FIG. 3 depicts an example configuration of a semiconductor device. A semiconductor device 1-1 includes a high voltage IC (HVIC) 100, a high-side switching circuit UD1, a high-side driving power supply VB, a low-side switching circuit LD1, a low-side driving power supply VCCL, a load 9, and a power supply V3.

The HVIC 100 includes a high-side circuit 10 and a low-side circuit 20. The high-side switching circuit UD1 includes a switching element SW1 and a temperature detection diode D1, and the low-side switching circuit LD1 includes a switching element SW2 and a temperature detection diode D2. A control unit 3, such as a microcomputer, is connected to the HVIC 100. The high-side circuit 10 and the low-side circuit 20 respectively receive driving control signals DgH and DgL transmitted from the control unit 3, and control respectively the driving of the switching elements SW1 and SW2 connected in a half bridge.

The switching elements SW1 and SW2 are insulated gate bipolar transistors (IGBTs), for example. Alternatively, power metal-oxide-semiconductor field-effect transistors (MOSFETs) may be used. The following description assumes that IGBTs are used.

The collector of the switching element SW1 is connected to the positive terminal of the power supply V3. The emitter of the switching element SW1 is connected to one end of the load 9, the cathode of the temperature detection diode D1, the negative terminal of the high-side driving power supply VB, and the collector of the switching element SW2. The emitter of the switching element SW2 is connected to the negative terminal of the power supply V3, the negative terminal of the low-side driving power supply VCCL, another end of the load 9, the cathode of the temperature detection diode D2, and GND.

The high-side circuit 10 is operated by a high-side driving power supply VB that uses a potential of a connection node n0 between the emitter of the switching element SW1 and the collector of the switching element SW2 as a reference potential VS.

The high-side circuit 10 receives a driving control signal DgH for the switching element SW1 transmitted from the control unit 3, generates a driving signal HO, and outputs the driving signal HO to the gate of the switching element SW1 to drive the switching element SW1.

The high-side circuit 10 provides overcurrent protection of the switching element SW1 according to a current signal HOC, which is based on a sensing current output from a sensing emitter of the switching element SW1 when the switching element SW1 is turned on.

The high-side circuit 10 also provides overheat protection of the switching element SW1 according to a temperature signal HOH based on the potential generated at the temperature detection diode D1 by the operating temperature of the switching element SW1.

On the other hand, the low-side circuit 20 is operated by a low-side driving power supply VCCL that uses GND as a reference potential. The low-side circuit 20 receives a driving control signal DgL for the switching element SW2 transmitted from the control unit 3, generates a drive signal LO, and outputs the drive signal LO to the gate of the switching element SW2 to drive the switching element SW2.

The low-side circuit 20 provides overcurrent protection of the switching element SW2 according to a current signal LOC, which is based on a sensing current output from a sensing emitter of the switching element SW2 when the switching element SW2 is turned on.

The low-side circuit 20 also provides overheat protection of the switching element SW2 according to a temperature signal LOH based on the potential generated at the temperature detection diode D2 by the operating temperature of the switching element SW2.

The low-side circuit 20 transmits a clock signal CLK to the high-side circuit 10, and the high-side circuit 10 transmits an operation detection pulse P0, which is generated from first operation information DH (temperature information, current information, and the like of the switching element SW1), to the low-side circuit 20 in synchronization with the clock signal CLK.

The low-side circuit 20 then aggregates the operation detection pulse generated from second operation information of the low-side switching element SW2 and the operation detection pulse P0 generated from the first operation information of the high-side switching element SW1, and transmits notification data Dout, which includes the aggregated operation information of the switching elements SW1 and SW2, to the control unit 3.

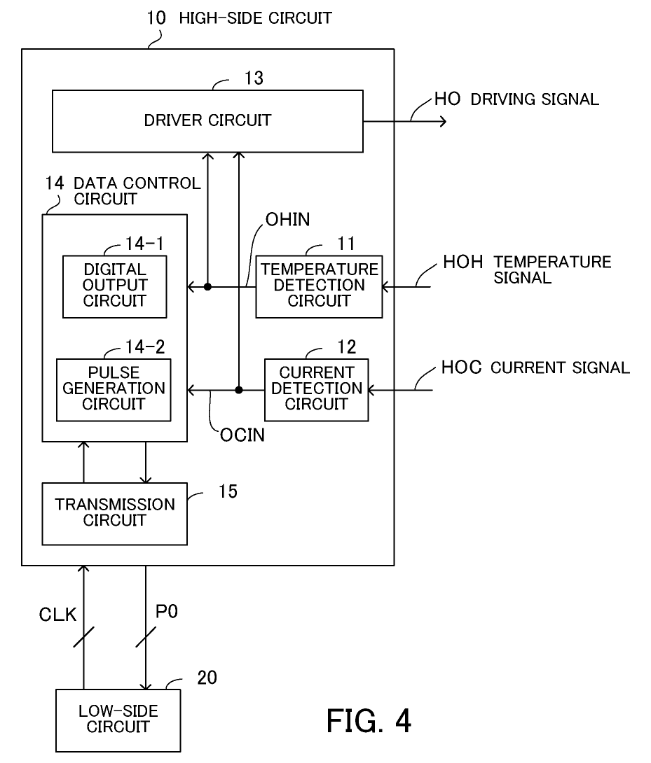

FIG. 4 depicts an example configuration of a high-side circuit. The high-side circuit 10 includes a temperature detection circuit 11, a current detection circuit 12, a driver circuit 13, and a data control circuit 14. The temperature detection circuit 11, the current detection circuit 12, and the data control circuit 14 correspond to the high-side operation detection circuit 1a1 in FIG. 1. The temperature detection circuit 11 detects the operating temperature of the high-side switching element SW1 based on a temperature signal HOH and outputs a temperature detection signal OHIN. The current detection circuit 12 detects a current flowing through the high-side switching element SW1 based on the current signal HOC, and outputs a current detection signal OCIN.

The driver circuit 13 outputs a driving signal HO to the gate of the switching element SW1 based on a driving control signal from the control unit 3. When the temperature detection signal OHIN transmitted from the temperature detection circuit 11 indicates an overheated state, the driver circuit 13 stops the outputting of the driving signal HO to turn off the switching element SW1. Also, when the current detection signal OCIN transmitted from the current detection circuit 12 indicates an overcurrent state, the driver circuit 13 stops the outputting of the driving signal HO to turn off the switching element SW1.

The data control circuit 14 includes a digital output circuit 14-1 and a pulse generation circuit 14-2. The digital output circuit 14-1 includes an A/D converter and a latch circuit, subjects the temperature detection signal OHIN and the current detection signal OCIN to A/D conversion to convert into digital signals, and holds the values of the digital signals.

The pulse generation circuit 14-2 generates an operation detection pulse for performing data transmission of a digital signal to the low-side circuit 20 based on the clock signal CLK transmitted from the low-side circuit 20.

The transmission circuit 15 has a level conversion function for clock transmission from the low side to the high side and data transmission from the high side to the low side. The transmission circuit 15 transmits the clock signal CLK transmitted from the low-side circuit 20 to the pulse generation circuit 14-2, and transmits the operation detection pulse P0 (that is a pulse including the first operation information of the high-side switching element SW1) generated by the pulse generation circuit 14-2 to the low-side circuit 20. The low-side circuit 20 transmits the notification data Dout obtained by aggregating the transmitted temperature/current information of the high-side switching element SW1 and the temperature/current information of the low-side switching element SW2 to the control unit 3.

Although an example configuration where detection of operation information of a switching element involves detection of temperature information and current information has been described, it is possible to further include voltage information. As examples, this voltage information is a voltage applied to the collector of the switching element or a voltage applied to the gate of the switching element.

In this case, the high-side circuit 10 transmits the operation detection pulse P0 including the detected voltage information to the low-side circuit 20 in synchronization with the clock signal CLK, and the low-side circuit 20 transmits the notification data Dout obtained by aggregating the transmitted voltage information of the high-side switching element SW1 and the voltage information of the low-side switching element SW2 to the control unit 3.

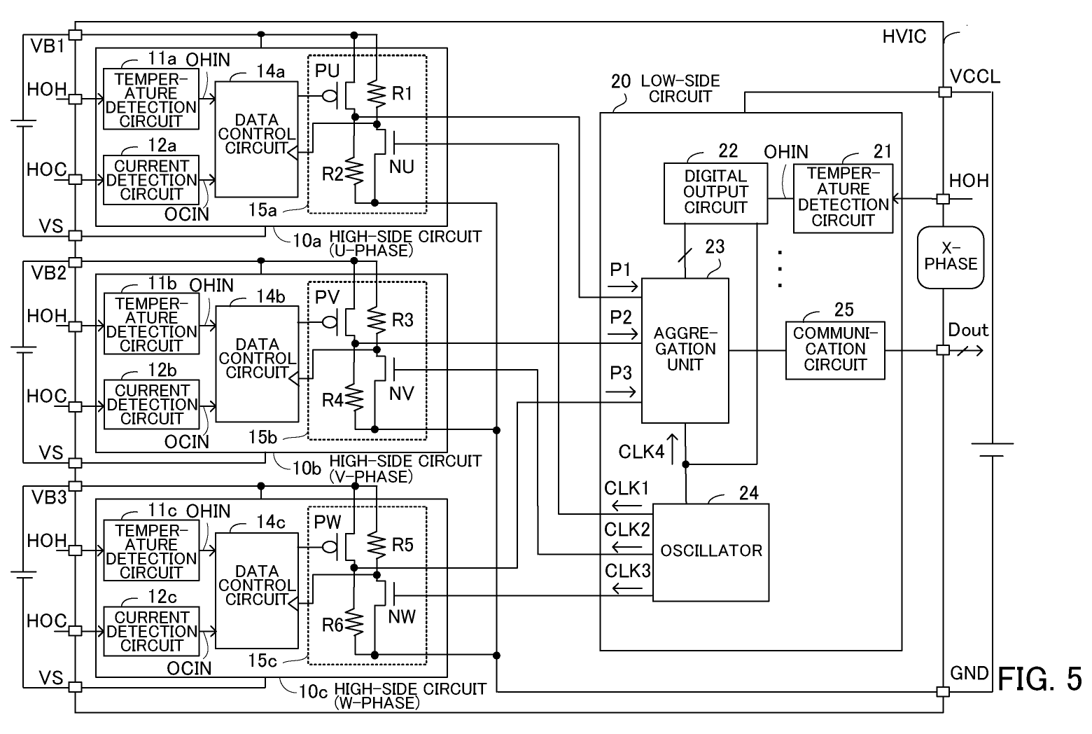

FIG. 5 depicts example internal configurations of a high-side circuit and a low-side circuit. The HVIC 100a includes a U-phase high-side circuit 10a, a V-phase high-side circuit 10b, a W-phase high-side circuit 10c, and a low-side circuit 20. Note that the respective driver circuits 13 of the high-side circuits 10a, 10b, and 10c are omitted in the drawing. The low-side circuit 20 indicates an example internal configuration for collecting temperature information for the X-phase.

The high-side circuit 10a includes a temperature detection circuit 11a, a current detection circuit 12a, a data control circuit 14a, and a transmission circuit 15a. The high-side circuit 10b includes a temperature detection circuit 11b, a current detection circuit 12b, a data control circuit 14b, and a transmission circuit 15b. The high-side circuit 10c includes a temperature detection circuit 11c, a current detection circuit 12c, a data control circuit 14c, and a transmission circuit 15c.

The low-side circuit 20 includes a temperature detection circuit 21, a digital output circuit 22, an aggregation unit 23, an oscillator 24 (clock circuit), and a communication circuit 25. The temperature detection circuit 21 and the digital output circuit 22 correspond to the low-side operation detection circuit 1b1 in FIG. 1. The aggregation unit 23, the oscillator 24, and the communication circuit 25 correspond to the operation information notification circuit 1b2 in FIG. 1.

The transmission circuit 15a in the high-side circuit 10a includes a p-channel metal–oxide–semiconductor (PMOS) transistor PU that is a high breakdown voltage transistor element, an n-channel metal–oxide–semiconductor (NMOS) transistor NU that is a high breakdown voltage transistor element, a resistor R1 (or "first resistor"), and a resistor R2 (or "second resistor").

The source of the PMOS transistor PU is connected to one end of the resistor R1, and the voltage of a high-side driving power supply VB1 is applied to the source of the PMOS transistor PU. The drain of the PMOS transistor PU is connected to one end of the resistor R2 and a first input terminal of the aggregation unit 23. The gate of the PMOS transistor PU is connected to an output terminal of the data control circuit 14a.

Another end of the resistor R1 is connected to the drain of the NMOS transistor NU and a clock input terminal of the data control circuit 14a. The source of the NMOS transistor NU is connected to the other end of the resistor R2 and GND. The gate of the NMOS transistor NU is connected to a first output terminal of the oscillator 24.

The transmission circuit 15b in the high-side circuit 10b includes a PMOS transistor PV as a high breakdown voltage transistor element, an NMOS transistor NV as a high breakdown voltage transistor element, a resistor R3 (or "first resistor"), and a resistor R4 (or "second resistor").

The source of the PMOS transistor PV is connected to one end of the resistor R3, and the voltage of a high-side driving power supply VB2 is applied to the source of the PMOS transistor PV. The drain of the PMOS transistor PV is connected to one end of the resistor R4 and a second input terminal of the aggregation unit 23. The gate of the PMOS transistor PV is connected to an output terminal of the data control circuit 14b.

The other end of the resistor R3 is connected to the drain of the NMOS transistor NV and a clock input terminal of the data control circuit 14b. The source of the NMOS transistor NV is connected to the other end of the resistor R4 and GND. The gate of the NMOS transistor NV is connected to a second output terminal of the oscillator 24.

The transmission circuit 15c in the high-side circuit 10c includes a PMOS transistor PW as a high breakdown voltage transistor element, an NMOS transistor NW as a high breakdown voltage transistor element, a resistor R5 (or "first resistor"), and a resistor R6 (or "second resistor").

The source of the PMOS transistor PW is connected to one end of the resistor R5, and the voltage of a high-side driving power supply VB3 is applied to the source of the PMOS transistor PW. The drain of the PMOS transistor PW is connected to one end of the resistor R6 and a third input terminal of the aggregation unit 23. The gate of the PMOS transistor PW is connected to an output terminal of the data control circuit 14c.

The other end of the resistor R5 is connected to the drain of the NMOS transistor NW and a clock input terminal of the data control circuit 14c. The source of the NMOS transistor NW is connected to the other end of the resistor R6 and GND. The gate of the NMOS transistor NW is connected to a third output terminal of the oscillator 24.

Note that although the low-side circuit 20 operates on a voltage (for example, 15 V) of the low-side driving power supply VCCL that has GND as a reference potential, each high-side circuit 10 operates using the high-side driving power supply VB that has VS, which is a floating potential, as a reference potential and therefore may fluctuate to around 800 V, for example. For this reason, high breakdown voltage transistor elements are used for the PMOS transistors and the NMOS transistors included in the transmission circuits 15 inside the high-side circuits 10.

### Transmission of Operation Information from U-Phase High-Side Circuit 10a to Low-Side Circuit 20

The oscillator 24 in the low-side circuit 20 outputs a clock signal CLK1 when operation information is to be collected from the U-phase high-side. The NMOS transistor NU is turned on in every H level cycle of the clock signal CLK1 by the clock signal CLK1 input into the gate. The clock signal CLK1 is then transmitted to the clock input terminal of the data control circuit 14a via the drain of the NMOS transistor NU.

On the other hand, the data control circuit 14a converts the temperature detection signal OHIN output from the temperature detection circuit 11a or the current detection signal OCIN output from the current detection circuit 12a into a digital signal to generate a serial operation detection pulse, and outputs the operation detection pulse to the gate of the PMOS transistor PU in synchronization with the clock signal CLK1.

The PMOS transistor PU is turned on in every L level cycle of the operation detection pulse input into the gate. An operation detection pulse P1 of temperature data or current data for the high-side U-phase switching element is then transmitted to the first input terminal of the aggregation unit 23 via the drain of the PMOS transistor PU.

### Transmission of Operation Information from V-Phase High-Side Circuit 10b to Low-Side Circuit 20

The oscillator 24 in the low-side circuit 20 outputs a clock signal CLK2 when operation information is to be collected from the V-phase high-side. The NMOS transistor NV is turned on in every H level cycle of the clock signal CLK2 by the clock signal CLK2 input into the gate. The clock signal CLK2 is transmitted to the clock input terminal of the data control circuit 14b via the drain of the NMOS transistor NV.

On the other hand, the data control circuit 14b converts the temperature detection signal OHIN output from the temperature detection circuit 11b or the current detection signal OCIN output from the current detection circuit 12b into a digital signal to generate a serial operation detection pulse, and outputs the operation detection pulse to the gate of the PMOS transistor PV in synchronization with the clock signal CLK2.

The PMOS transistor PV is turned on in every L level cycle of the operation detection pulse input into the gate. An operation detection pulse P2 of temperature data or current data for the high-side V-phase switching element is then transmitted to the second input terminal of the aggregation unit 23 via the drain of the PMOS transistor PV.

### Transmission of Operation Information from W-Phase High-Side Circuit 10c to Low-Side Circuit 20

The oscillator 24 in the low-side circuit 20 outputs a clock signal CLK3 when operation information is to be collected from the W-phase high-side. The NMOS transistor NW is turned on in every H level cycle of the clock signal CLK3 by the clock signal CLK3 input into the gate. The clock signal CLK3 is transmitted to the clock input terminal of the data control circuit 14c via the drain of the NMOS transistor NW.

On the other hand, the data control circuit 14c converts the temperature detection signal OHIN output from the temperature detection circuit 11c or the current detection signal OCIN output from the current detection circuit 12c into a digital signal to generate a serial operation detection pulse, and outputs the operation detection pulse to the gate of the PMOS transistor PW in synchronization with the clock signal CLK3.

The PMOS transistor PW is turned on in every L level cycle of the operation detection pulse input into the gate. An operation detection pulse P3 of temperature data or current data for the high-side W-phase switching element is then transmitted to the third input terminal of the aggregation unit 23 via the drain of the PMOS transistor PW.

### Outputting Operation Information Aggregated by Low-Side Circuit 20 to Periphery

The low-side circuit 20 notifies the control unit 3 of temperature information as a notification of the operation information. The temperature detection circuit 21 detects the operating temperature of the low-side switching element based on the X-phase temperature signal HOH, and outputs a temperature detection signal OHIN. The digital output circuit 22 subjects the temperature detection signal OHIN to A/D conversion to convert the temperature detection signal OHIN into a digital signal, and holds the value of the digital signal. The digital output circuit 22 receives a clock signal CLK4 output from the fourth output terminal of the oscillator 24, and transmits an operation detection pulse relating to temperature to the aggregation unit 23 in synchronization with the clock signal CLK4.

The aggregation unit 23 receives the clock signal CLK4 and aggregates the operation detection pulses P1, P2, and P3 transmitted from the high-side circuits 10a, 10b, and 10c and the low-side X-phase operation detection pulse output from the digital output circuit 22. The communication circuit 25 then performs communication interface control with the communication destination and outputs the aggregated data as the notification data Dout to the periphery. As one example, the communication circuit 25 outputs the notification data Dout to the control unit 3. Note that the notification data Dout also includes a clock signal (for example, the clock signal CLK4).

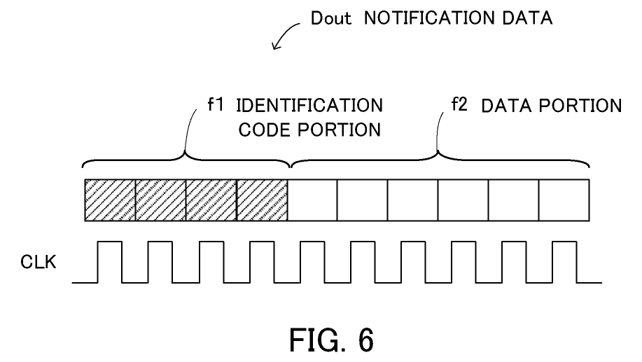

FIG. 6 is a diagram depicting an example of bit allocation in the notification data. The notification data Dout has an identification code portion f1 and a data portion f2. In the example in FIG. 6, the data is 10-bit data, the upper 4 bits are the identification code portion f1, and the remaining 6 bits are the data portion f2.

A first identification code, which relates to the phase of the switching element, and a second identification code, which relates to the operation information, are inserted into the identification code portion f1. The first identification code indicates the phase on which a high-side switching element or a low-side switching element is disposed (for example, a U-phase switching element). The second identification code indicates whether the operation state of the high-side switching element or the low-side switching element is a temperature state, current information, or voltage information. The data portion f2 corresponds to a payload region and indicates information of digital data that is a detection value of an operation state of a high-side switching element or a low-side switching element.

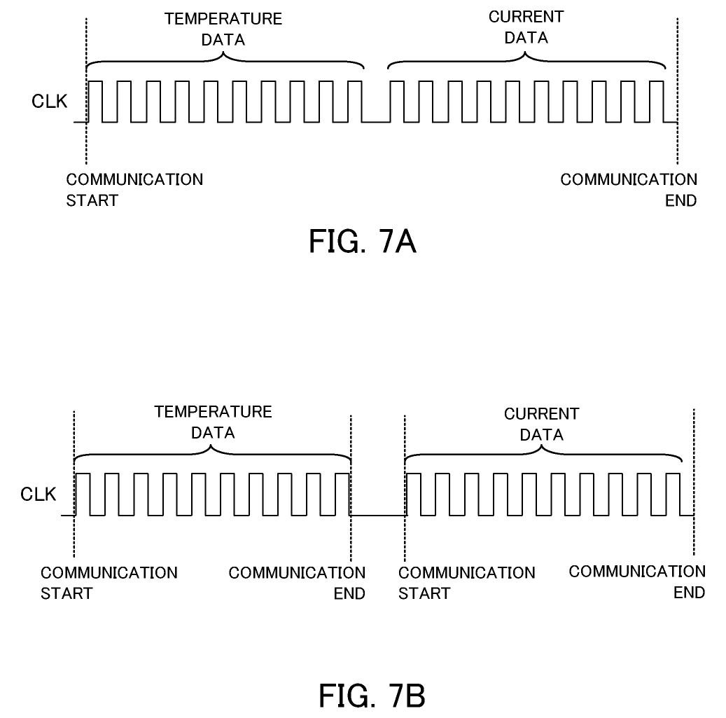

FIGS. 7A and 7B depict example waveforms of a clock signal indicating a communication start and a communication end of an operation detection pulse. FIG. 7A depicts a case where a plurality of pieces of operation information are transmitted during a period from the start of communication to the end of communication, and FIG. 7B depicts a case where a single piece of operation information is transmitted during a period from the start of communication to the end of communication.

When the low-side circuit 20 collects the operation information from a high-side circuit 10, the low-side circuit 20 transmits the clock signal CLK to the predetermined high-side circuit 10. On detecting the clock signal CLK, the high-side circuit 10 determines a start of communication and transmits an operation detection pulse to the low-side circuit 20. The high-side circuit 10 determines an end to data communication after the data is transmitted.

On the other hand, as data transmission from a high-side circuit 10 to the low-side circuit 20, it is also possible, as depicted in FIG. 7A, to insert and transmit a plurality of pieces of operation information, such as temperature data and current data, in a section from the start of communication to the end of communication.

Alternatively, as depicted in FIG. 7B, a single piece of operation information may be transmitted in one period from the start of communication to the end of communication, so that temperature data is inserted in one period from the start of communication to the end of communication and current data is inserted in a different period from the start of communication to the end of communication.

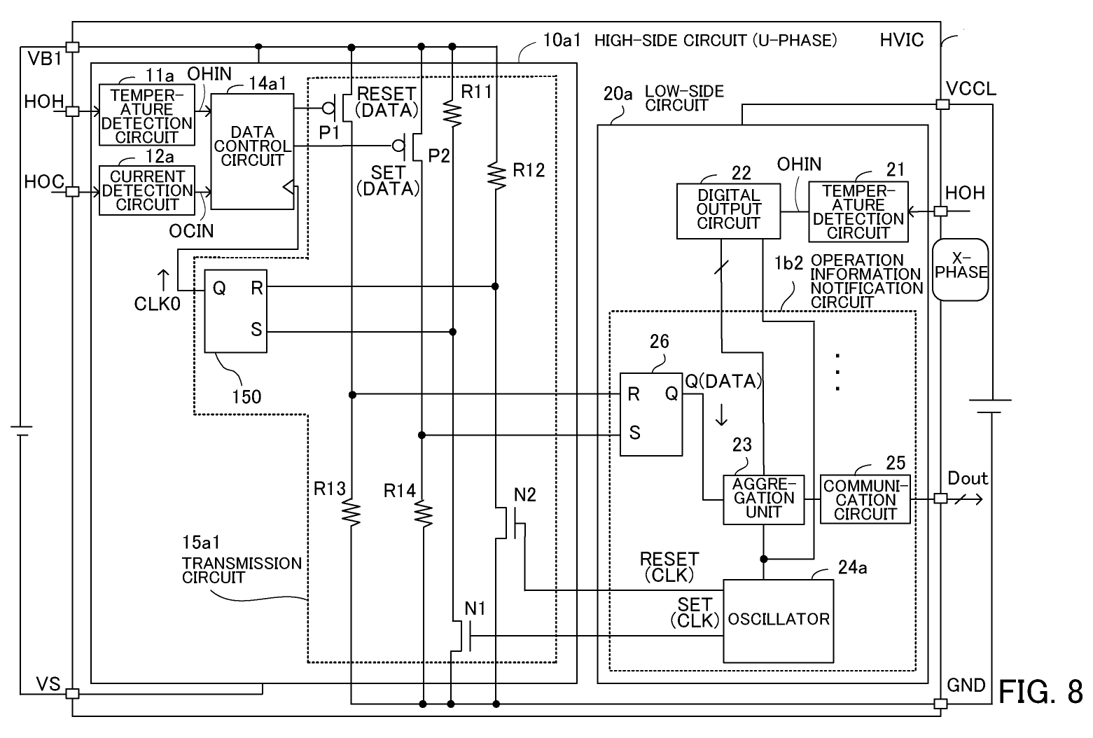

FIG. 8 depicts the configuration of a modification of an HVIC. On the high side, only the internal configuration of a U-phase high-side circuit 10a1 is depicted, with the high-side circuits on the V phase and the W phase being omitted. An HVIC 100b according to this modification includes a high-side circuit 10a1 and a low-side circuit 20a. Note that the driver circuit 13 of the high-side circuit 10a1 has been omitted from the drawing. The low-side circuit 20a depicts an example internal configuration for collecting temperature information for the X-phase.

The high-side circuit 10a1 includes the temperature detection circuit 11a, the current detection circuit 12a, a data control circuit 14a1, and a transmission circuit 15a1.

The low-side circuit 20a includes the temperature detection circuit 21, the digital output circuit 22, the aggregation unit 23, an oscillator 24a (clock circuit), the communication circuit 25, and an RS flip-flop 26 (or "low-side RS flip-flop"). The RS flip-flop 26 is included in the functions of the operation information notification circuit 1b2.

The transmission circuit 15a1 in the high-side circuit 10a1 includes an RS flip-flop 150 (or "high-side RS flip-flop"), a PMOS transistor P1 (or "first PMOS transistor"), a PMOS transistor P2 (or "second PMOS transistor"), an NMOS transistor N1 (or "first NMOS transistor"), an NMOS transistor N2 (or "second NMOS transistor"), a resistor R11 (or "first resistor"), a resistor R12 (or "second resistor"), a resistor R13 (or "third resistor"), and a resistor R14 (or "fourth resistor").

With the configuration according to this modification, the data control circuit 14a1 outputs parallel operation detection pulses from the first and second output terminals. The transmission circuit 15a1 includes two NMOS transistors N1 and N2 for inputting reset and set clock signals into the RS flip-flop 150, and two PMOS transistors P1 and P2 for transmitting the parallel operation detection pulses to the low-side circuit 20.

The source of the PMOS transistor P1 is connected to the source of the PMOS transistor P2, one end of the resistor R11, and one end of the resistor R12, and the voltage of the high-side driving power supply VB1 is applied to the source of the PMOS transistor P1. The drain of the PMOS transistor P1 is connected to one end of the resistor R13 and a reset input terminal R of the RS flip-flop 26. The gate of the PMOS transistor P1 is connected to a first output terminal of the data control circuit 14a1. An output terminal Q of the RS flip-flop 26 is connected to an input terminal of the aggregation unit 23.

The drain of the PMOS transistor P2 is connected to one end of the resistor R14 and a set input terminal S of the RS flip-flop 26. The gate of the PMOS transistor P2 is connected to a second output terminal of the data control circuit 14a1.

The other end of the resistor R11 is connected to a set input terminal S of the RS flip-flop 150 and the drain of the NMOS transistor N1. The other end of the resistor R12 is connected to a reset input terminal R of the RS flip-flop 150 and the drain of the NMOS transistor N2. An output terminal Q of the RS flip-flop 150 is connected to a clock input terminal of the data control circuit 14a1.

SET (CLK), which is a set clock signal output from the oscillator 24a, is input into the gate of the NMOS transistor N1, and RESET (CLK), which is a reset clock signal output from the oscillator 24a, is input into the gate of the NMOS transistor N2. Note that the oscillator 24a also outputs a clock signal to the aggregation unit 23 and the digital output circuit 22 in the same way as in FIG. 5. The other end of the resistor R13 is connected to the other end of the resistor R14, the source of the NMOS transistor N1, the source of the NMOS transistor N2, and GND.

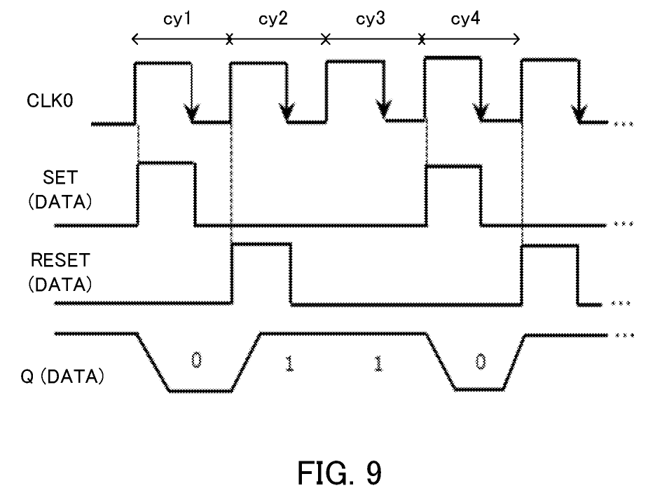

FIG. 9 is an example timing chart of operation waveform pulse transmission. CLK0 is a clock signal output from the RS flip-flop 150 and input into the data control circuit 14a1.

SET (DATA) is data input into the set input terminal S of the RS flip-flop 26 when the PMOS transistor P2 is turned on/off by an output (a "second operation detection pulse") from the second output terminal of the data control circuit 14a1.

RESET (DATA) is data input into the reset input terminal R of the RS flip-flop 26 when the PMOS transistor P1 is turned on/off by an output (a "first operation detection pulse") from the first output terminal of the data control circuit 14a1. Q (DATA) is data output from the output terminal Q of the RS flip-flop 26.

When SET (DATA) is indicated as S, RESET (DATA) is indicated as R, and Q (DATA) is indicated as Q, the relationships between truth values are expressed as (S, R, Q) = (1, 0, 0), (S, R, Q) = (0, 0, hold), and (S, R, Q) = (0, 1, 1).

Cycle cy1 SET (DATA) becomes the H level at the rising edge of CLK0 and the L level at the falling edge of CLK0. RESET (DATA) is at the L level. Accordingly, Q (DATA) transitions to the L level from the rising edge in CLK0.

Cycle cy2 SET (DATA) is at the L level. RESET (DATA) becomes the H level at the rising edge of CLK0 and the L level at the falling edge of CLK0. Accordingly, Q (DATA) transitions to the H level from the rising edge in CLK0.

Cycle cy3 SET (DATA) is at the L level. RESET (DATA) is at the L level. Therefore, Q (DATA) maintains the H level.

Cycle cy4 SET (DATA) becomes the H level at the rising edge of CLK0 and the L level at the falling edge of CLK0. RESET (DATA) is at the L level. Accordingly, Q (DATA) transitions to the L level from the rising edge in CLK0.

As described above, when an operation detection pulse is transmitted from the high side to the low side, the operation detection pulse is transmitted in synchronization with the clock signal generated by the low-side circuit 20a. As one example, when the high-side circuit 10a1 changes the output of Q (DATA) to “0”, SET (DATA) is turned on, and when Q (DATA) is changed from “0” to “1”, RESET (DATA) is turned on.

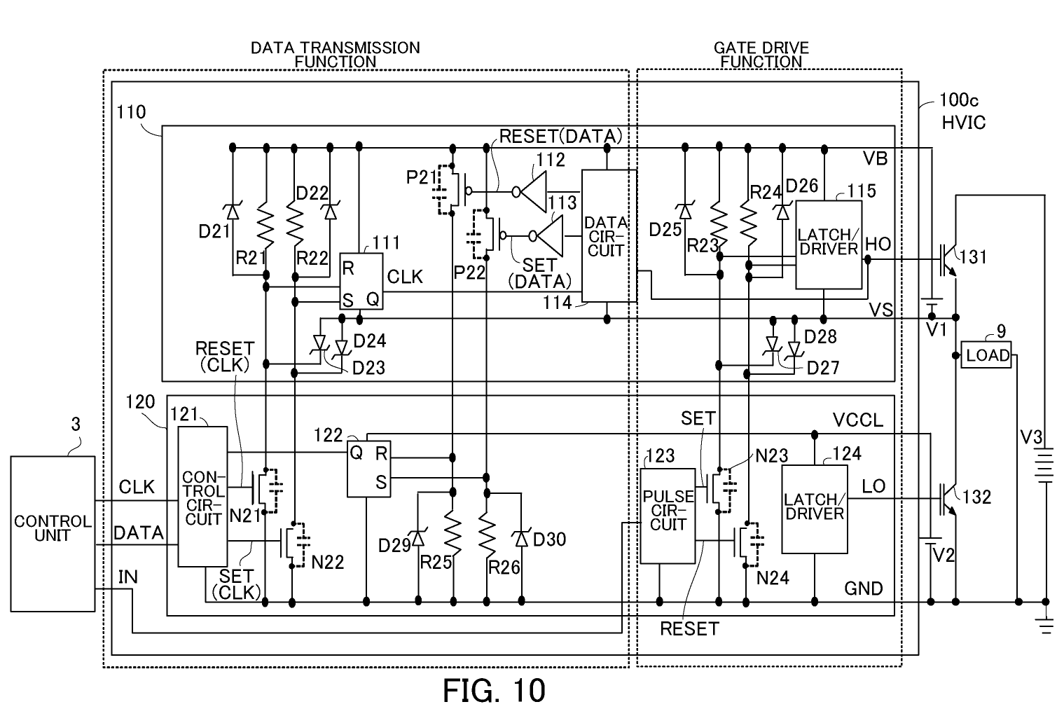

FIG. 10 depicts the configuration of a modification to an HVIC that includes a gate drive function. An HVIC 100c includes a high-side circuit 110 and a low-side circuit 120. The HVIC 100c includes IGBTs 131 and 132 in an output unit, with the load 9 and power supplies V1, V2, and V3 connected to this output unit. Also in the HVIC 100c in FIG. 10, configurations of a data transmission function for transmitting an operation detection pulse and a gate drive function for driving the IGBT are illustrated.

The data transmission function of the high-side circuit 110 includes an RS flip-flop 111, inverter elements 112 and 113, a data (high-side data) circuit 114, diodes D21, D22, D23, and D24, resistors R21 and R22, and PMOS transistors P21 and P22.

The gate drive function of high-side circuit 110 includes a latch/driver 115, diodes D25, D26, D27, and D28, and resistors R23 and R24. Note that parasitic capacitance exists between the source and drain of the PMOS transistors P21 and P22. The diodes D21 to D28 are elements for stabilizing fluctuations in potential between a voltage VB and a reference potential VS, with Zener diodes being used as one example.

On the other hand, the data transmission function of the low-side circuit 120 includes a control circuit 121, an RS flip-flop 122, diodes D29 and D30, resistors R25 and R26, and NMOS transistors N21 and N22.

The gate drive function of the low-side circuit 120 includes a pulse circuit 123, a latch/driver 124, and NMOS transistors N23 and N24. Note that a parasitic capacitance exists between the drain and the source of the NMOS transistors N21 to N24. The diodes D29 and D30 are elements for stabilizing fluctuations in potential between a voltage VCCL and GND, with Zener diodes being used as one example.

The positive terminal of the power supply V1 is connected to the cathodes of the diodes D21, D22, D25, and D26, one end of each of the resistors R21, R22, R23, and R24, the sources of the PMOS transistors P21 and P22, a power supply terminal of the data circuit 114, and a power supply terminal of the latch/driver 115.

The negative terminal of the power supply V1 is connected to the anodes of the diodes D23, D24, D27, and D28, a ground terminal of the RS flip-flop 111, a ground terminal of the data circuit 114, and a ground terminal of the latch/driver 115. The negative terminal of the power supply V1 is also connected to the emitter of the IGBT 131, one end of the load 9, and the collector of the IGBT 132.

The anode of the diode D21 is connected to the other end of the resistor R21, the reset input terminal R of the RS flip-flop 111, the cathode of the diode D23, and the drain of the NMOS transistor N21.

The anode of the diode D22 is connected to the other end of the resistor R22, the set input terminal S of the RS flip-flop 111, the cathode of the diode D24, and the drain of the NMOS transistor N22.

An output terminal Q of the RS flip-flop 111 is connected to a clock input terminal of the data circuit 114. The drain of the PMOS transistor P21 is connected to the reset input terminal R of the RS flip-flop 122, the cathode of the diode D29, and one end of the resistor R25. The drain of the PMOS transistor P22 is connected to the set input terminal S of the RS flip-flop 122, the cathode of the diode D30, and one end of the resistor R26.

An input terminal of the inverter element 112 is connected to a first output terminal of the data circuit 114, and an input terminal of the inverter element 113 is connected to a second output terminal of the data circuit 114. The output terminal of the inverter element 112 is connected to the gate of the PMOS transistor P21, and the output terminal of the inverter element 113 is connected to the gate of the PMOS transistor P22.

The anode of the diode D25 is connected to the other end of the resistor R23, a first input terminal of the latch/driver 115, the cathode of the diode D27, and the drain of the NMOS transistor N23.

The anode of the diode D26 is connected to the other end of the resistor R24, a second input terminal of the latch/driver 115, the cathode of the diode D28, and the drain of the NMOS transistor N24. An output terminal of the latch/driver 115 is connected to the gate of the IGBT 131 and the input terminal of the data circuit 114.

The positive terminal of the power supply V2 is connected to a power supply terminal of the RS flip-flop 122 and a power supply terminal of the latch/driver 124. The negative terminal of the power supply V2 is connected to a ground terminal of the control circuit 121, a ground terminal of the RS flip-flop 122, the sources of the NMOS transistors N21 and N22, the anodes of the diodes D29 and D30, the other ends of the resistors R25 and R26, a ground terminal of the pulse circuit 123, the sources of the NMOS transistors N23 and N24, and a ground terminal of the latch/driver 124. The negative terminal of the power supply V2 is also connected to the emitter of the IGBT 132, the other end of the load 9, the negative terminal of the power supply V3, and GND. The positive terminal of the power supply V3 is connected to the collector of the IGBT 131.

A first clock output terminal (CLK) of the control circuit 121 is connected to a clock input terminal of the control unit 3. A data output terminal (DATA) of the control circuit 121 is connected to a data input terminal of the control unit 3. A pulse generation instruction (IN) output from the control unit 3 is input into an input terminal of the pulse circuit 123.

A clock input terminal of the control circuit 121 is connected to an output terminal Q of the RS flip-flop 122. A second clock output terminal (RESET (CLK)) of the control circuit 121 is connected to the gate of the NMOS transistor N21, and a third clock output terminal (SET (CLK)) of the control circuit 121 is connected to the gate of the NMOS transistor N22.

A first output terminal of the pulse circuit 123 is connected to the gate of the NMOS transistor N23, and a second output terminal of the pulse circuit 123 is connected to the gate of the NMOS transistor N24. An output terminal of the latch/driver 124 is connected to the gate of the IGBT 132.

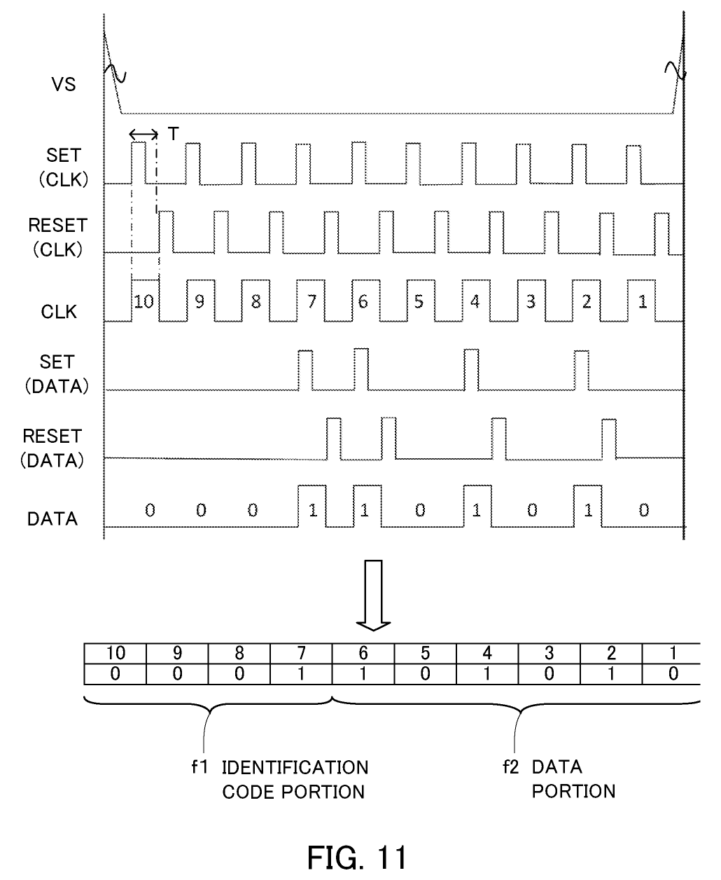

FIG. 11 is an example timing chart of the data transmission function. RESET (CLK) is input into the gate of the NMOS transistor N21, and SET (CLK) is input into the gate of the NMOS transistor N22. The phases of SET (CLK) and RESET (CLK) are shifted to be a period T apart.

SET (CLK) is input via the NMOS transistor N22 into the set input terminal S of the RS flip-flop 111, and RESET (CLK) is input via the NMOS transistor N21 into the reset input terminal R of the RS flip-flop 111.

Accordingly, the clock signal CLK that is at the H level from a rising edge in SET (CLK) to a rising edge in RESET (CLK) and at the L level from the rising edge in RESET (CLK) to the next rising edge in SET (CLK) is output from the output terminal Q of the RS flip-flop 111.

Here, it is assumed that the following data is output from the inverter elements 112 and 113 for each bit of the clock signal CLK.

For the 10th, 9th, and 8th bits of the clock signal CLK SET (DATA) at the L level is output from the inverter element 113, and RESET (DATA) at the L level is output from the inverter element 112.

For the 7th bit of the clock signal CLK The inverter element 113 outputs SET (DATA) at the H level when the clock signal CLK is at the H level, and the inverter element 112 outputs RESET (DATA) at the H level when the clock signal CLK is at the L level.

For the 6th bit of the clock signal CLK The inverter element 113 outputs SET (DATA) at the H level when the clock signal CLK is at the H level, and the inverter element 112 outputs RESET (DATA) at the H level when the clock signal CLK is at the L level.

For the 5th bit of the clock signal CLK The inverter element 113 outputs SET (DATA) at the L level, and the inverter element 112 outputs RESET (DATA) at the L level

For the 4th bit of the clock signal CLK The inverter element 113 outputs SET (DATA) at the H level when the clock signal CLK is at the H level, and the inverter element 112 outputs RESET (DATA) at the H level when the clock signal CLK is at the L level.

For the 3rd bit of the clock signal CLK The inverter element 113 outputs SET (DATA) at the L level, and the inverter element 112 outputs RESET (DATA) at the L level.

For the 2nd bit of the clock signal CLK The inverter element 113 outputs SET (DATA) at the H level when the clock signal CLK is at the H level, and the inverter element 112 outputs RESET (DATA) at the H level when the clock signal CLK is at the L level.

For the 1st bit of the clock signal CLK The inverter element 113 outputs SET (DATA) at the L level, and the inverter element 112 outputs RESET (DATA) at the L level.

Since RESET (DATA) and SET (DATA) with the values given above are input into the reset input terminal R and the set input terminal S of the RS flip-flop 122, respectively, the following data is output from the output terminal Q of the RS flip-flop 122.

For the 10th, 9th, and 8th bits of the clock signal CLK Data “0” is output from the output terminal Q of the RS flip-flop 122.

For the 7th bit of the clock signal CLK Data “1” is output from the output terminal Q of the RS flip-flop 122 from a rising edge in SET (DATA) to a rising edge in RESET (DATA).

For the 6th bit of the clock signal CLK Data “1” is output from the output terminal Q of the RS flip-flop 122 from a rising edge in SET (DATA) to a rising edge in RESET (DATA).

For the 5th bit of the clock signal CLK Data “0” is output from the output terminal Q of the RS flip-flop 122.

For the 4th bit of the clock signal CLK Data “1” is output from the output terminal Q of the RS flip-flop 122 from a rising edge in SET (DATA) to a rising edge in RESET (DATA).

For the 3rd bit of the clock signal CLK Data “0” is output from the output terminal Q of the RS flip-flop 122.

For the 2nd bit of the clock signal CLK Data “1” is output from the output terminal Q of the RS flip-flop 122 from a rising edge in SET (DATA) to a rising edge in RESET (DATA).

For the 1st bit of the clock signal CLK Data “0” is output from the output terminal Q of the RS flip-flop 122.

As described above, the data “0001101010” is output from the RS flip-flop 122 to the control circuit 121 for the tenth bit to the first bit of the clock signal CLK. The control circuit 121 transmits the data DATA “0001101010” and the clock signal CLK to the control unit 3 to notify the control unit 3 of operation information for the high side. The 10th to 7th bits of the data are the identification code portion f1, and 6th to 1st bits of the data are the data portion f2.

As described above, according to the present embodiment, high-side operation information and low-side operation information are aggregated and sent as notification to the periphery. By doing so, the number of pins for outputting operation information, such as an alarm signal, to the periphery is reduced to one, which reduces the scale of the apparatus and promotes miniaturization.

According to one aspect, it is possible to miniaturize an apparatus by reducing the scale of the apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A semiconductor device, comprising:
an output unit that is connected to a load and includes a high-side switching element and a low-side switching element for driving the load;
a high-side circuit, including:
a high-side operation detection circuit, which detects an operation state of the high-side switching element and generates first operation information, and
a transmission circuit, which transmits the first operation information; and
a low-side circuit, including:
a low-side operation detection circuit, which detects an operation state of the low-side switching element and generates second operation information, and
an operation information notification circuit, which receives the first operation information transmitted by the transmission circuit of the high-side circuit and the second operation information, and notifies a periphery of the semiconductor device of data that includes at least one of the first operation information or the second operation information.

2. The semiconductor device according to claim 1, wherein
the high-side operation detection circuit detects at least one of a temperature state, a current state, or a voltage state of the high-side switching element and generates the first operation information, and
the low-side operation detection circuit detects at least one of a temperature state, a current state, or a voltage state of the low-side switching element and generates the second operation information.

3. The semiconductor device according to claim 2, wherein
the operation information notification circuit includes a clock circuit that generates a clock signal,
the high-side operation detection circuit includes a data control circuit,
the transmission circuit receives the clock signal from the operation information notification circuit, and transmits the clock signal to the data control circuit,
the data control circuit converts the first operation information into a digital signal, and generates an operation detection pulse from the digital signal based on the clock signal, and
the transmission circuit transmits the operation detection pulse to the operation information notification circuit.

4. The semiconductor device according to claim 3, wherein
the transmission circuit includes:
a p-channel metal–oxide–semiconductor (PMOS) transistor as a first high breakdown voltage transistor element,
an n-channel metal–oxide–semiconductor (NMOS) transistor as a second high breakdown voltage transistor element,
each of the PMOS transistor and the NMOS transistor having a source, a drain and a gate,
a first resistor, and
a second resistor,
each of the first and second resistors having a first end and a second end;
the high-side circuit has a power supply terminal;
the clock circuit has an output terminal from which the clock signal is output;
the data control circuit has:
a clock input terminal into which the clock signal is input, and
an output terminal from which the operation detection pulse is output;
the first end of the first resistor is connected to the power supply terminal of the high-side circuit and the source of the PMOS transistor;
the second end of the first resistor is connected to the drain of the NMOS transistor and the clock input terminal of the data control circuit;
the gate of the NMOS transistor is connected to the output terminal of the clock circuit;
the gate of the PMOS transistor is connected to the output terminal of the data control circuit;
the drain of the PMOS transistor is connected to the first end of the second resistor; and
the second end of the second resistor is connected to the source of the NMOS transistor and grounded.

5. The semiconductor device according to claim 2, wherein
the operation information notification circuit includes a clock circuit that generates a clock signal,
the high-side operation detection circuit includes a data control circuit,
the transmission circuit receives the clock signal from the operation information notification circuit, and transmits the clock signal to the data control circuit,
the data control circuit converts the first operation information into a digital signal, and generates a first operation detection pulse and a second operation detection pulse from the digital signal based on the clock signal, and
the transmission circuit transmits the first operation detection pulse and the second operation detection pulse to the operation information notification circuit.

6. The semiconductor device according to claim 5, wherein
the transmission circuit includes:
a first p-channel metal–oxide–semiconductor (PMOS) transistor as a first high breakdown voltage transistor element,
a second PMOS transistor as a second high breakdown voltage transistor element,
a first n-channel metal–oxide–semiconductor (NMOS) transistor as a third high breakdown voltage transistor element,
a second NMOS transistor as a fourth high breakdown voltage transistor element,
each of the first and second PMOS transistors and the first and second NMOS transistors having a source, a drain and a gate,
a first resistor,
a second resistor,
a third resistor,
a fourth resistor,
each of the first, second, third and fourth resistors having a first end and a second end, and
a high-side RS flip-flop;
the high-side circuit has a power supply terminal;
the operation information notification circuit further includes a low-side RS flip-flop, each of the high-side RS flip-flop and the low-side RS flip-flop having a set input terminal and a reset input terminal;
the clock circuit has:
a first output terminal from which a set clock signal is output, and
a second output terminal from which a reset clock signal is output;
the first end of the first resistor is connected to the power supply terminal of the high-side circuit, the source of the first PMOS transistor, the source of the second PMOS transistor, and the first end of the second resistor;
the second end of the first resistor is connected to the set input terminal of the high-side RS flip-flop and the drain of the first NMOS transistor;
the second end of the second resistor is connected to the reset input terminal of the high-side RS flip-flop and the drain of the second NMOS transistor;
the gate of the first NMOS transistor is connected to the first output terminal of the clock circuit;
the gate of the second NMOS transistor is connected to the second output terminal of the clock circuit;
the gate of the first PMOS transistor is connected to the first output terminal of the data control circuit;
the gate of the second PMOS transistor is connected to the second output terminal of the data control circuit;
the drain of the first PMOS transistor is connected to the reset input terminal of the low-side RS flip-flop and the first end of the third resistor;
the drain of the second PMOS transistor is connected to the set input terminal of the low-side RS flip-flop and the first end of the fourth resistor; and
the second end of the third resistor is connected to the second end of the fourth resistor, the source of the first NMOS transistor, and the source of the second NMOS transistor and grounded.

7. The semiconductor device according to claim 1, wherein
the data of which the operation information notification circuit notifies the periphery of the semiconductor device includes:
an identification code portion including
a first identification code, which indicates a phase in which the high-side switching element or the low-side switching element is disposed, and
a second identification code, which indicates any one of temperature information, current information, and voltage information,
as the first or second operation information; and
a data portion which is a detection data value of the operation state of the high-side switching element or that of the low-side switching element.
